(19) United States
(12) Patent Application Publication
(10) Pub. No.: US 2011/0305103 A1
(43) Pub. Date: Dec. 15, 2011

(54) Hydrodynamic cavitation device

(76) Inventors: Dennis McGuire, Stuart, FL (US); Sanjeev Jakhete, Stuart, FL (US)

(21) Appl. No.: 12/816,014

(22) Filed: Jun. 15, 2010

(51) Int. Cl. B01F 5/06

(52) U.S. Cl. 366/337

(57) ABSTRACT

A hydrodynamic cavitation device formed from a cylindrical tube having a flow-through chamber. The chamber includes a series of baffle units each unit formed from a first plate defined by a first end spaced apart from a second end by a length. The first plate includes a curved outer edge sized to follow the inner side wall of the chamber and a straight inner edge extending from the first end to the second end along the approximate center line of the chamber and positioned at a 45 degree angle relative to the longitudinal length of the tube. A second plate, forming a mirror image of the first plate, is also positioned at a 45 degree angle relative to the longitudinal length of the tube and at a 90 degree angle to the first plate. Each plate includes a plurality of apertures sized to control the velocity of the fluid flow, each aperture having edge walls to induce constriction for hydrodynamic cavitation mixing of fluids.

### FIELD OF THE INVENTION

This invention relates to fluid handling and, more particularly, to an apparatus for creating hydrodynamic cavitations in a fluid stream.

### BACKGROUND OF THE INVENTION

In-line fluid flow static mixers are known in the art and generally consist of mixing baffles arranged so that when a material is discharged from one baffle, it discharges with a swirling action and strikes the downstream baffle. The fluid flow divides before it passes on to the next succeeding baffle, which again divides the flow into various streams. While this type of mixer has achieved commercial success for mixing, use of a static mixer is ineffective with many high viscosity fluids. U.S. Pat. Nos. 4,511,258 and 4,936,689 disclose static mixer having a sinuous cross-section with each section being axially staggered with respect to another section, however, no teaching is made on presenting such a mixer to highly viscous materials. In addition, such mixers would be economically unfeasible in situations wherein a high flow rate and rapid mixing is required.

Hydrodynamic cavitation is the result of a flow constriction wherein a liquid falls below the vapor pressure and forms vapor-filled gas bubbles. If the static pressure then increases and exceeds the vapor pressure, these vapor-filled gas bubbles collapse implosively. Cavitation and the associated effects are also known to be useful in mixing, emulsifying and dispersing various components in a flowing liquid. The mixing action is based on a large number of forces originating from the collapsing or implosion of cavitation bubbles. If during the process of movement of the fluid the pressure at some point decreases to a magnitude under which the fluid reaches a boiling point for this pressure, then a great number of vapor-filled cavities and bubbles are formed. Insofar as the vapor-filled bubbles and cavities move together with the fluid flow, these bubbles and cavities may move into an elevated pressure zone. Where these bubbles and cavities enter a zone having increased pressure, vapor condensation takes place within the cavities and bubbles, almost instantaneously, causing the cavities and bubbles to collapse, creating very large pressure impulses. The magnitude of the pressure impulses within the collapsing cavities and bubbles may reach ultra high pressures implosions leading to the formation of shock waves that emanate from the point of each collapsed bubble.

Hydrodynamic cavitation typically takes place by the flow of a liquid under controlled conditions through various geometries. The phenomenon consists in the formation of hollow spaces which are filled with a vapor gas mixture in the interior of a fast-flowing liquid flow or at peripheral regions of a fixed body which is difficult for the fluid to flow around and the result is a local pressure drop caused by the liquid movement. At a particular velocity the pressure may fall below the vapor pressure of the liquid being pumped, thus causing partial vaporization of the cavitating fluid. With the reduction of pressure there is liberation of the gases which are dissolved in the cavitating liquid. These gas bubbles also oscillate and the give rise to the pressure and temperature pulses.

It is known that devices exist in the art which utilize the passage of a hydrodynamic flow through a cylindrical flow-through chamber having a series of baffles confronting the direction of hydrodynamic flow to produce varied cavitation effects. The baffles provide a local contraction of the flow as the fluid flow confronts the baffle element thus increasing the fluid flow pressure. As the fluid flow passes the baffle, the fluid flow enters a zone of decreased pressure downstream of the baffle element thereby creating a hydrodynamic cavitation field. U.S. Pat. No. 5,492,654 discloses a cylindrical flow-through chamber having internally disposed baffles. In this disclosure the upstream baffle elements have a larger diameter than the downstream baffle elements. Such a device is utilized in an attempt to create and control hydrodynamic cavitation in fluids wherein the position of the baffle elements is variable.

Although the hydrodynamic cavitation devices exist in the prior art, there is nevertheless a need for improvement in many respects to provide a fluid shearing effect.

### SUMMARY OF THE INVENTION

Disclosed is a hydrodynamic cavitation device for use in high flow rate situations where instant mixing is required. The device is formed from a cylindrical tube having a flow-through chamber constructed in arranged to cause hydrodynamic cavitation. The chamber includes a series of baffle units, each unit is formed from a first plate defined by a first end spaced apart from a second end by a length. The first plate includes a curved outer edge sized to follow the inner side wall of the chamber and a straight inner edge extending from the first end to the second end along the approximate center line of the chamber and positioned at a 45 degree angle relative to the longitudinal length of the tube. A second plate, forming a mirror image of the first plate, is also positioned at a 45 degree angle relative to the longitudinal length of the tube and at a 90 degree angle to the first plate. Each plate includes a plurality of apertures sized to control the velocity of the fluid flow, each aperture having edge walls to induce cavitation.

It is an objective of the instant invention to improve upon the prior art, in particular, to improve upon a known geometric shape used in static mixers for fluid treatment by use of hydrodynamic cavitation. The improvements including strategically placed flow thru apertures and angular placement of plates to cause predetermined pressure differentials and caviations effects, and the sizing of components to accommodate the higher flow rates and need for instant mixing.

It is another objective of the instant invention to provide a hydrodynamic cavitation device which can operate at higher mixing efficiencies than other competitive devices.

It is an another objective of the instant invention to provide a hydrodynamic cavitation device having baffles positioned along alternating 45 degree angled plates allowing higher flow rates with predictable pressure losses.

It is yet another objective of the instant invention to provide a hydrodynamic cavitation device having angular positioning of baffles to provide for continuous flushing of suspended solids to prevent clogging.

Yet still another objective of the instant invention is to provide an improved hydrodynamic cavitation device having baffles sized and shaped to prevent clogging of a pipe with a broken baffle by eliminating any possibility of a baffle turning to a right angle to the fluid flow.

These and other objects and advantages of the present invention will become readily apparent as the invention is better understood by reference to the accompanying summary, drawings and the detailed description that follows.

### BRIEF DESCRIPTION OF THE DRAWINGS

FIG. 1 is a cross-sectional side view of the hydrodynamic cavitation device.

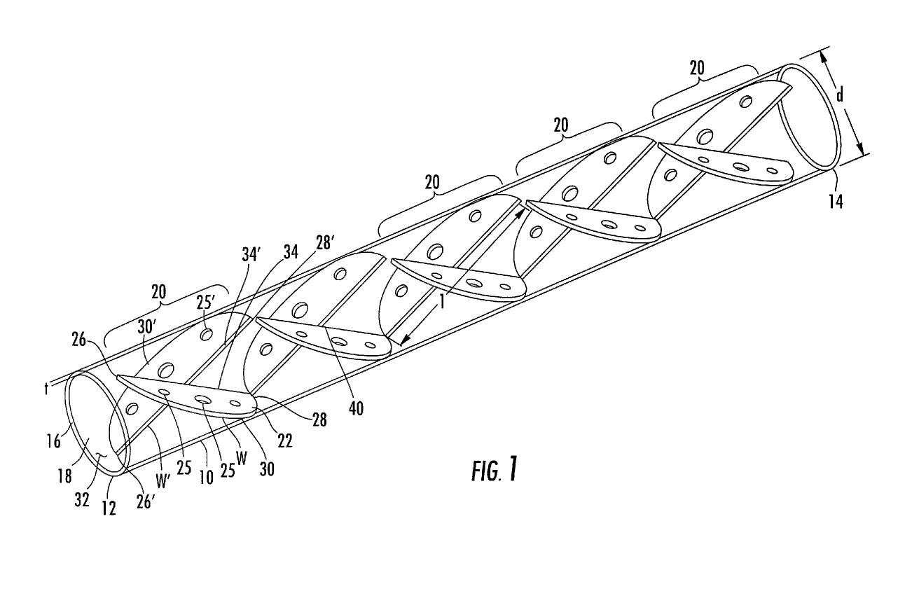

### DETAILED DESCRIPTION OF THE INVENTION

Now referring to the drawing set forth a cylindrical tube 10 having an inlet 12 and an outlet 14 with a continuous side wall 16 of thickness (t). The interior portion of the cylindrical tube forms a flow-through chamber 18 having a predetermined diameter (d). A first baffle unit 20 is positioned within the chamber and consists of a first plate' 22 and a second plate 24. The first plate 22 is defined by a first end 26 spaced from a second end 28 by a length (l) which is approximately twice the diameter of the chamber. The first plate has a width (w) which is approximately the same thickness (t) of the continuous side wall. The first plate is further defined by a curved outer edge 30, crescent shaped, sized to follow the inner side wall 32 of the cylindrical tube and has a straight inner edge 34 extending from the first end 26 to the second end 28 along the approximate center line of the cylindrical tube chamber 18. Apertures 25 are positioned in the plate in a predetermined size, number and position calculated to provide optimum cavitation with minimal pressure loss. Low iron content stainless steel, titanium, or certain thermoplastics is suitable for the high flow operation with minimal erosion of the plate edges.

The second plate 28 forms a mirror image of the first plate. For illustration the second plate is defined by a first end 26′ spaced from a second end 28′ by a length (l) which is approximately twice the diameter of the chamber. The second plate has a width (w) which is also approximately the thickness (t) of the continuous side wall. The second plate is further defined by a curved outer edge 30′ sized to follow the inner side wall 32 of the cylindrical tube and has a straight inner edge 34′ extending from the first end 26′ to the second end 28′ along the approximate center line of the cylindrical tube chamber 18.

The first plate 22 is positioned at a right angle (90 degrees) to second plate 24 along junction point 40. The junction point can be a weldment, pinion position, or be frictionally secured by use of an interference fit. The device for creating hydrodynamic cavitation in fluids according to claim 1 wherein each said plate includes a plurality of apertures. The apertures are flow thru and each includes a fluid orifice formed by the use of sharp edges that cause fluid passage so that each aperture is formed perpendicular to the plate and thus positioned at an angle to the fluid flow to create a constriction area.

The cross-sectional profile design creates the flow constriction area along the edges 34 and 34′ and edges to apertures 25 and 25′. The shape edges on the exit side of each edge form vena contract eddys and fluid shearing. A high fluid flow velocity provides for a hydrodynamic cavitation field downstream of each baffle unit. The flow velocity in a local constriction is increased while the pressure is decreased, with the result that the cavitation voids are formed in the fluid flow past the baffle unit to form cavitation bubbles which create the cavitation field. The cavitation bubbles enter into the increased pressure zone resulting from a reduced flow velocity, and collapse. The resulting cavitation exerts a physico-chemical effect on the liquid.

The baffle units 20 are placed end to end with baffle units of mirror construction in a sinuous cross-section. The improvement over U.S. Pat. No. 4,511,258, the contents of which is incorporated herein by reference, is directed to the configuration of the baffles designed for high flow rates by use of strategically positioned flow thru apertures. Each aperture is sized to a plate and requires fixed certain diameter to match the length, width, and thickness of the plate, all of which are constructed and arranged to induce hydrodynamic cavitation by implosion of the cavitation induced increased pressure zone where coordinated collapsing occurs, accompanied by high local pressure (up to 1500 MPa) and temperature (up to 15,000 degree K.), as well as by other physico-chemical effects which initiate the progress of chemical reactions in the fluid that can change the composition of the mixture.

As the fluid flow passes from one baffle unit to a second, the low pressure may be created in a localized area of the fluid by the constriction of flow as the fluid flows therethrough. Hydrodynamic cavitation may also include collapsing the cavitation bubbles thereby producing local energy conditions like heating, high pressure, that may lead to chemical bond breakage and partial oxidation of organic compounds. Collapsing the cavitation bubbles may occur in a zone or area of high or elevated pressure. it is believed that after a fluid flows through a local constriction, there may be an area downstream of the local constriction where cavitation bubbles are forming, completely formed cavitation bubbles are found may be called a cavitation field.

Cavitation bubbles generally contain gases and vapors. Collapsing the cavitation bubbles produce localized high energy conditions including high pressures and high temperatures requiring the baffles to be formed from a corrosive resistant material. When gases are present, high temperatures occur when the cavitation bubbles collapse and plasmas are created. The plasmas may emit ultraviolet light and the ultraviolet light may be emitted as pulses. Emission of this ultraviolet light may be called cavitation luminescence. The ultraviolet light may irradiate oxidizing agents contained within and/or associated with the cavitation bubbles. Irradiating oxidizing agents may produce ionization of the oxidizing agents. Irradiating oxidizing agents may produce hydroxyl radicals. The hydroxyl radicals may contact and/or react with organic compounds in a fluid or solution in which the cavitation bubbles are produced. These reactions may destroy or degrade the organic compounds, through breakage of chemical bonds within the compounds, for example. These reactions may produce partial oxidation of the organic compounds. These reactions may produce complete oxidation of the organic compounds, to carbon dioxide and water, for example. The fluid or solution that has been treated by the cavitation-based methods may be called a product of the methods.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for enhancing hydrodynamic cavitation in fluids comprising: a cylindrical housing having an inlet and an outlet with a continuous side wall forming a flow-through chamber therebetween defining an inner diameter; a plurality of baffles positioned end to end and fixedly disposed within said flow-through chamber, each baffle formed from a first crescent shaped plate defined by a proximal end spaced apart from a distal end by a length approximately measuring twice the diameter of said chamber, said first crescent shaped plate have a straight inner edge extending between said proximal and said distal end and a curved outer edge constructed and arranged to conform to the inner diameter of said chamber, said first plate having a center width measuring approximately one half the diameter of the inner diameter of said chamber and a second crescent shaped plate forming a minor image and positioned substantially perpendicular to said first crescent shaped plate; each said plate having at least one flow thru aperture constructed and arranged to form shear inducing angular shaped passageways through each plate; wherein passage of a fluid through said cylindrical housing results in the creation of a hydrodynamic cavitation field through fluid shearing around each plate and through the flow-thru aperture of each plate.

2. The device for creating hydrodynamic cavitation in fluids according to claim 1 wherein said straight inner edge is shaped to induce fluid shearing.

3. The device for creating hydrodynamic cavitation in fluids according to claim 1 wherein each said flow through aperture is sized to control the velocity of fluid flow through said housing.

4. The device for creating hydrodynamic cavitation in fluids according to claim 1 wherein each said aperture is sized to provide a predetermined pressure drop for a volume of fluid flow through said housing.

5. The device for creating hydrodynamic cavitation in fluids according to claim 1 wherein each said distal end of the first plate of a first baffle is secured to a distal end of first plate of a second baffle, and said distal end of the second plate of a first baffle is secured to a distal end of a first plate of a second baffle

6. The device for creating hydrodynamic cavitation in fluids according to claim 1 wherein said first plate and second plate are secured to each other along said junction point formed at the perpendicular crossing of a first and second plate.

7. The device for creating hydrodynamic cavitation in fluids according to claim 1 wherein adjoining baffles are staggered.
